(19) United States
(12) Patent Application Publication
(10) Pub. No.: US 2009/0280424 A1
(43) Pub. Date: Nov. 12, 2009

(54) Toner for developing electrostatically charged image and process for producing the same

(76) Inventors: Hirotoshi Ikeya, Shizuoka-shi (JP); Hiroshi Kumashiro, Shizuoka-shi (JP); Nobuyuki Aoki, Shizuoka-shi (JP)

Correspondence Address: JORDAN AND HAMBURG LLP, 122 EAST 42ND STREET, SUITE 4000, NEW YORK, NY, 10168, US

(21) Appl. No.: 12/387,627

(22) Filed: May 5, 2009

(30) Foreign Application Priority Data
May 6, 2008 (JP) 2008-120810

(51) Int. Cl. G03G 9/08; G03G 9/00; G03G 5/00

(52) U.S. Cl. 430/108.4; 430/108.1; 430/137.2

(57) ABSTRACT

Provided as toners for developing electrostatically charged images capable of preventing a sticking and curling phenomenon even with an increase in number of printed sheets and processes for producing the same, with the use of a cyclic polyolefinic resin, are a toner for developing electrostatically charged images contains a cyclic polyolefinic resin and a polar resin wherein 10 to 50 parts by weight of the polar resin is present in relation to 100 parts by weight of the cyclic polyolefinic resin, and a process for producing a toner for developing electrostatically charged images comprises a step of melt-kneading at least a cyclic polyolefinic resin and a coloring agent to obtain a kneaded product, a step of grinding the kneaded product to obtain colored particles, and a step of melt-kneading, grinding and classifying the colored particles and a polar resin to obtain the toner.

### BACKGROUND OF THE INVENTION

The present invention relates to toners for developing electrostatically charged images to be used for electrophotography and electrographic recording as well as processes for producing the same.

Conventionally, cyclic polyolefinic resins (cycloolefinic resins) are discussed as binder resins that are main components of toners, in addition to styrene-acrylic resins and polyester-based resins.

Although such cyclic polyolefinic resins possess various excellent characteristics such as colorlessness and transparency, good thermal characteristics (low-temperature fixation and high-speed fixation), sharpened molecular weight distributions, good grindability (high productivities and sharpened particle size distributions), low water absorption, odorlessness and pollution-freeness, they suffer a disadvantage that they are likely to develop a phenomenon in which transfer papers stick to and curl around fixation rollers when toners are fixed.

As such, in order to eliminate the disadvantage, techniques have been proposed in which cyclized polyisoprene is added (refer to Patent Reference 1, for example) or an elastomer is added (refer to Patent Reference 2, for example) among others.

It is however not easy to uniformly disperse the cyclized polyisoprene or elastomer in cyclic polyolefinic resins, with variations caused in quality of dispersion depending on toner particles.

Therefore, a so-called selective phenomenon disadvantageously occurs in which toners having good dispersibility and electrification may preferentially be consumed in developing vessels, with a result that the sticking and curling phenomenon will increase with an increase in number of printed sheets.

Patent Reference 1: Japanese Unexamined Patent Publication No. 2003-035971

Patent Reference 2: Japanese Unexamined Patent Publication No. 2005-292362

### SUMMARY OF THE INVENTION

The present invention has been made in the light of the problem as described above and has an object to provide toners for developing electrostatically charged images capable of preventing a sticking and curling phenomenon even with an increase in number of printed sheets and processes for producing the same, with the use of a cyclic polyolefinic resin.

The present invention has successfully solved the problem described above by means of technical constitution to be described below.

(1) A toner for developing electrostatically charged images, containing a cyclic polyolefinic resin and a polar resin, wherein 10 to 50 parts by weight of the polar resin is present in relation to 100 parts by weight of the cyclic polyolefinic resin.

(2) The toner for developing electrostatically charged images according to (1) above, further containing a compatibilizer.

(3) The toner for developing electrostatically charged images according to (2) above, wherein the compatibilizer is a polymer having both non-polar and polar segments.

(4) The toner for developing electrostatically charged images according to (1) above, wherein the polar resin is a styrene-acrylic resin or polyester-based resin.

(5) The toner for developing electrostatically charged images according to any one of (1) to (4) above, further containing a wax.

(6) A process for producing a toner for developing electrostatically charged images, comprising a step of melt-kneading at least a cyclic polyolefinic resin and a coloring agent to obtain a kneaded product, a step of grinding the kneaded product to obtain colored particles, and a step of melt-kneading, grinding and classifying the colored particles and a polar resin to obtain the toner.

According to the present invention, toners for developing electrostatically charged images capable of preventing a sticking and curling phenomenon even with an increase in number of printed sheets and processes for producing the same, with the use of a cyclic polyolefinic resin, may be provided.

### DETAILED DESCRIPTION OF THE INVENTION

The toner for developing electrostatically charged images according to the present invention (hereinafter also referred to as the toner) contain a cyclic polyolefinic resin and a polar resin, wherein 10 to 50 parts by weight of the polar resin is present in relation to 100 parts by weight of the cyclic polyolefinic resin.

Cyclic Polyolefinic Resin

Cyclic polyolefinic resins contain at least one cyclic olefin, and the following polymers (a), (b), (c) and so on can be exemplified:

(a) homopolymers made of one cyclic olefin;

(b) copolymers made of two or more cyclic olefins; and

(c) copolymers made of cyclic olefin(s) and non-cyclic unsaturated monomer(s).

Examples of cyclic olefins may include cyclic and/or polycyclic olefinic compounds having at least one double bond, for example, monocyclic olefins such as cyclobutene, cyclopentene, cyclohexene, cycloheptene and cyclooctene or derivatives thereof; cyclic conjugated dienes such as cyclopentadiene, cyclohexadiene, cycloheptadiene and cyclooctadiene or derivatives thereof; polycyclic olefins such as norbornene, dicyclopentadiene, tricyclodecene, tetracyclododecene and hexacycloheptadecene or derivatives thereof; vinyl cyclic hydrocarbons such as vinylcyclobutane, vinylcyclobutene, vinylcyclopentane, vinylcyclopentene, vinylcyclohexane, vinylcyclohexene, vinylcycloheptane, vinylcycloheptene, vinylcyclooctane and vinylcyclooctene or derivatives thereof as well as hydrides of aromatic ring moieties of vinyl aromatic monomers such as styrene or derivatives thereof.

These cyclic olefins may be used alone or in combination of two or more.

The derivatives described above may include alkyl-substituted derivatives, alkylidene-substituted derivatives, alkoxy-substituted derivatives, acyl-substituted derivatives, halogen-substituted derivatives and carboxy-substituted derivatives.

The number of carbon atoms for composing the cyclic structures may be usually from 4 to 30, preferably from 5 to 20 and more preferably from 5 to 15, in view of properties such as moldability and transparency.

The cyclic polyolefinic resin may preferably be (c) among (a), (b) and (c) described above in terms of grindability, processability, mechanical properties, and the like.

The non-cyclic unsaturated monomers are not particularly limited, as long as they are copolymerizable with cyclic olefins, examples of which may include olefinic monomers; (meth)acrylic monomers; (meth)acrylate ester-based monomers such as (meth)acrylate C₁₋₆ alkylesters such as methyl(meth)acrylate, ethyl (meth)acrylate and butyl(meth)acrylate; vinylated ester monomers such as vinyl acetate and vinyl propionate; cyanided vinylic monomers such as (meth)acrylonitrile; and diene-based monomers such as butadiene, 1,4-pentadiene and isoprene.

These non-cyclic unsaturated monomers may be used alone or in combination of two or more.

Olefinic monomers may preferably be used among the non-cyclic unsaturated monomers in terms of conferring flexibility to toners.

Examples of olefinic monomers may include α-C₂₋₁₀ olefins (preferably α-C₂₋₆ olefins and more preferably α-C₂₋₄ olefins) such as ethylene, propylene, 1-butylene, 1-pentene, 1-hexene, 1-heptene and 1-octene and branched olefins such as isobutene and isoprene.

These olefins may be used alone or in combination of two or more.

Ethylene and propylene are particularly preferred among these olefins.

The amount of non-cyclic unsaturated monomers to be used may be selected within the range of 100 mol or lower, preferably 1 to 90 mol and more preferably 1 to 80 mol in relation to 100 mol of a cyclic olefin.

Among the cyclic polyolefinic resins, copolymers of ethylene or propylene with norbornene (ethylene-norbornene copolymer, propylene-norbornene copolymer, and the like) may preferably be used as specific examples of (c). Those having no unsaturated double bonds and being colorless and transparent with high light transmittance are preferred.

The cyclic polyolefinic resins may contain 10 to 40% by weight of a molecular weight substance having a molecular weight of 40,000 or more as determined by gel permeation chromatography and preferably contain 5 to 20% by weight of a molecular weight substance having a molecular weight of 400,000 or more as determined by gel permeation chromatography.

The glass transition temperatures of (c) are determined by composition ratios between the cyclic olefins and the non-cyclic unsaturated monomers and are usually from 50 to 200° C. Selection may be made as appropriate depending on applications and molding temperatures.

For use as toners, the glass transition temperatures are from 50 to 80° C., preferably from 50 to 70° C. and more preferably from 50 to 65° C.

The cyclic polyolefinic resins may be introduced with carboxyl groups, hydroxyl groups, amino groups or the like according to any known methods.

Further, the cyclic polyolefinic resins introduced with carboxyl groups may be introduced with crosslinked structures through addition of metals such as zinc, copper and calcium.

Introduction of these substituents or metal crosslinked structures may improve fixation characteristics and also improve miscibility with other resins or coloring agents at the time of toner production, therefore improving toner moldability.

Polar Resin

Polar resins are not particularly limited as long as they are polar and may preferably be styrene-acrylic resins or polyester-based resins. Styrene-acrylic resins are smaller in specific gravity than other resins, therefore contributing to a reduction in toner consumption. In addition, polyester-based resins have good color development and glossness and are excellent in mechanical durability.

Further, among polyester resins, biodegradable polyhydroxyalkanoate resins are more preferably used in view of environmental consideration.

The loadings of a polar resin are necessarily from 10 to 50 parts by weight in relation to 100 parts by weight of a cyclic polyolefinic resin.

Below 10 parts by weight, sticking and curling may occur. Also, above 50 parts by weight, odor may be generated or otherwise, preventing the cyclic polyolefinic resin from sufficiently exhibiting its characteristics.

The loadings are more preferably from 15 to 33 parts by weight and are most preferably at approximately 25 parts by weight.

Compatibilizer

The toners according to the present invention may preferably further contain a compatibilizer.

Compatibilizers are not particularly limited as long as they compatibilize cyclic olefinic resins and polar resins and may preferably be block copolymers having both non-polar and polar segments.

The non-polar segments may preferably be olefinic segments.

An olefinic segment is a segment of polymerized olefinic monomers or copolymerized olefinic and styrenic monomers.

Examples of olefinic monomers may include ethylene, propylene, methyl pentene, butadiene and norbornene derivatives.

The olefinic monomers may be used alone or in combination of two or more.

Also, the polar segments may preferably be ester-based segments or styrenic segments.

An ester-based segment is a segment of polycondensed alcoholic monomers and acid-based monomers.

Examples of alcoholic monomers for use include α,ω-alkylene diols (C2 to C12) such as ethylene glycol, 1,3-propylene glycol, 1,4-butane diol, 1,6-hexane diol, 1,8-octane diol, 1,10-decane diol and 1,12-dodecane diol; polyalkylene glycols such as diethylene glycol, triethylene glycol and dipropylene glycol; aliphatic dihydroxy alcohols such as 1,2-propane diol, neopentyl glycol and 1,4-cyclohexane dimethanol; polyhydroxy alcohols such as glycerin, 1,1,1-tris(4-hydroxyphenyl)ethane, trimethylol ethane, trimethylol propane and saccharides such as monosaccharides, disaccharides, ring-opened saccharides and modified saccharides; bisphenols such as 2,2-bis(4-hydroxyphenyl)propane, bis(4-hydroxyphenyl)methane, 1,1-bis(4-hydroxyphenyl)cyclohexane, 2,2-bis(3-methyl-4-hydroxyphenyl)propane, 2,2-bis(3-phenyl-4-hydroxyphenyl)propane, 4,4′-dihydroxydiphenylsulfone, 4,4′-dihydroxydiphenylether and bis(4-hydroxyphenyl)diphenylmethane; those bisphenols whose hydroxyl groups are modified with alkylene glycols such as polyethylene glycol and polypropylene glycol; and those bisphenols whose aromatic rings are hydrogenated.

Examples of acid-based monomers for use include saturated aliphatic carboxylic acids such as succinic acid, adipic acid, azelaic acid, sebacic acid and octylsuccinic acid; unsaturated aliphatic carboxylic acids such as maleic acid, fumaric acid and maleic anhydride; cycloaliphatic carboxylic acids such as 1,2-cyclohexane dicarboxylic acids, 1,4-cyclohexane dicarboxylic acids and 2,3-bicyclo[2,2,1]dicarboxylic acids; aromatic dicarboxylic acids such as terephthalic acid, isophthalic acid, phthalic acid and naphthalene dicarboxylic acids; and polyvalent carboxylic acids having a valence of three or more, such as trimellitic acid, trimellitic anhydride, pyromellitic acid, pyromellitic anhydride, 1,2,4-cyclohexane tricarboxylic acids, 1,2,4-cyclohexane tricarboxylic anhydrides, 1,2,4-butane tricarboxylic acids, 1,2,4-butane tricarboxylic anhydrides, 2,5,7-naphthalene tricarboxylic acids, 1,2,4-naphthalene tricarboxylic acids and 1,2,4-naphthalene tricarboxylic anhydrides.

The carboxylic acids here may be acid halides, esters or acid anhydrides.

Also a styrenic segment is a segment of polymerized styrenic monomers or copolymerized styrenic and acrylic monomers.

Examples of styrenic monomers include styrene, o-methyl styrene, m-methyl styrene, p-methyl styrene, p-ethyl styrene, 2,4-dimethyl styrene, p-n-butyl styrene, p-tert-butyl styrene, p-n-hexyl styrene, p-n-octyl styrene, p-n-nonyl styrene, p-n-decyl styrene, p-n-dodecyl styrene, p-methoxy styrene, p-phenyl styrene, p-chlorostyrene and 3,4-dichlorostyrene.

Examples of acrylic monomers include n-butyl methacrylate, isobutyl methacrylate, ethyl acrylate, n-butyl acrylate, methyl methacrylate, glycidyl methacrylate, dimethylaminoethyl methacrylate, diethylaminoethyl methacrylate, diethylaminopropyl acrylate, 2-ethylhexyl acrylate, butyl acrylate-N-(ethoxymethyl)acrylamide, ethyleneglycol methacrylate and 4-hexafluorobutyl methacrylate.

The acrylic monomers may be used alone or in combination of two or more.

The monomers mentioned above may also be modified.

An example of such a compatibilizer is CERAMER series from Baker Petrolite Corporation.

The compatibilizers may also be polymerized with other monomers.

Such other monomers for use include vinylic monomers, for example, vinyl ester-based monomers such as vinyl acetate, vinyl propionate, vinyl benzoate and vinyl butyrate, vinyl ether-based monomers such as vinyl methyl ether, vinyl ethyl ether and vinyl butyl ether, and vinyl ketone-based monomers such as vinyl methyl ketone, vinyl hexyl ketone and vinyl isopropenyl ketone as well as diene-based monomers such as isoprene and 2-chlorobutadiene.

The loadings of a compatibilizer may be preferably from 1 to 15 parts by weight and more preferably from 1 to 5 parts by weight in relation to 100 parts by weight of a cyclic polyolefinic resin.

Coloring Agent

Coloring agents to be used for the toners according to the present invention are black pigments for black toners and magenta pigments, cyan pigments, yellow pigments and so on for color toners.

As black pigments, carbon black may usually be used. Any carbon black may be used regardless of number average particle diameter, oil absorption, pH or the like. Commercially available products include trade names REGAL 400, 660, 330, 300 and SRF-S and STERLING SO, V, NS and R from Cabot Corporation of US; trade names RAVEN H20, MT-P, 410, 420, 430, 450, 500, 760, 780, 1000, 1035, 1060 and 1080 from Colombian Carbon Japan Ltd.; and trade names #5B, #10B, #40, #2400B and MA-100 from Mitsubishi Chemical Corporation. These carbon black products may be used alone or in combination of two or more.

The proportion of carbon black in the toners according to the present invention may range from 0.1 to 20% by weight, preferably from 1 to 10% by weight and more preferably from 1 to 5% by weight (in particular, from 1 to 3% by weight). When the proportion of carbon black is too low, the image density will decrease, and when the proportion is too high, the image quality will be apt to degrade, also degrading toner moldability. In addition to carbon black, black magnetic powders such as iron oxide and ferrite may also be used as black pigments.

As magenta pigments, such pigments as C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 202, 206, 207 and 209; C. I. Pigment Violet 19; and C. I. Vat Red 1, 2, 10, 13, 15, 23, 29 and 35 may be used. These magenta pigments may be used alone or in combination of two or more.

As cyan pigments, such pigments as C. I. Pigment Blue 2, 3, 15, 16 and 17; C. I. Vat Blue 6; and C. I. Acid Blue 45 may be used. These cyan pigments may be used alone or in combination of two or more.

As yellow pigments, such pigments as C. I. Pigment Yellow 1, 2, 3, 4, 5, 6, 7, 10, 11, 12, 13, 14, 15, 16, 17, 23, 65, 73, 74, 83, 93, 94, 97, 155 and 180 may be used. These yellow pigments may be used alone or in combination of two or more.

For full-color pigments, C. I. Pigment Red 57 and 122 as magenta pigments; C. I. Pigment Blue 15 as a cyan pigment; and C. I. Pigment Yellow 17, 93, 155 and 180 as yellow pigments may preferably be used, in view of color mixture and color reproduction properties.

The proportion of color pigments in the toners according to the present invention may range from 1 to 20% by weight, preferably from 3 to 10% by weight and more preferably from 4 to 9% by weight (in particular, from 4.5 to 8% by weight). When the proportion of such pigments is below the ranges described above, the image density will decrease, while the proportion is higher than the ranges, the electrification stability will be apt to degrade, also degrading the image quality. In addition, a disadvantage will arise in terms of cost.

In addition, so-called master batches in which pigments are dispersed in advance at high densities in resins that may become binder resins may be used for color pigments.

Charge control agents may be added to the toners according to the present invention, as necessary.

Charge control agents applied to the present invention are classified into positively chargeable charge control agents and negatively chargeable charge control agents according to their applications.

Examples of positively chargeable charge control agents may include Nigrosine and Nigrosine modified by fatty acid metal salts or the like, quaternary ammonium salts such as tributylbenzylammonium-1-hydroxy-4-naphtholsulfonate and tetrabutylammonium tetrafluoroborate; diorganotin oxides such as dibutyltin oxide, dioctyltin oxide and dicyclohexyltin oxide; diorganotin borates such as dibutyltin borate, dioctyltin borate and dicyclohexyltin borate; pyridium salts; azines; triphenylmethane-based compounds; and low molecular weight polymers having cationic functional groups.

These positively chargeable charge control agents may be used alone or in combination of two or more.

Nigrosine-based compounds and quaternary ammonium salts are preferably used as such positively chargeable charge control agents.

Examples of negatively chargeable charge control agents may include organometallic compounds such as acetylacetone metal complexes, monoazo metal complexes, naphthoic acid- or salicylic acid-based metal complexes or salts; chelates; and low molecular weight polymers having anionic functional groups.

These negatively chargeable charge control agents may be used alone or in combination of two or more.

Salicylic acid-based metal complexes and monoazo metal complexes are preferably used as such negatively chargeable charge control agents.

The loadings of a charge control agent may range usually from 0.1 to 5% by weight, preferably from 0.5 to 4% by weight and more preferably from 1 to 4% by weight in relation to 100% by weight of a resin composition.

In addition, the charge control agents are preferably colorless or pale in color for use in color toners.

The toners according to the present invention may preferably contain a wax as a mold release agent.

Examples of waxes may include polyolefinic waxes such as polyethylene wax, polypropylene wax and modified polyethylene wax; synthetic waxes such as Fischer Tropsch wax; petroleum-based waxes such as paraffin wax and microcrystalline wax; carnauba wax; candelilla wax; rice wax; and hydrogenated castor oil.

These waxes may be used alone or in combination of two or more.

The content of a wax in a toner may range from 0.1 to 10% by weight, preferably from 0.5 to 7% by weight and more preferably from 1 to 5% by weight.

When the loadings of a wax are within the ranges described above, fusion resistance, toner moldability and releasability may be counterbalanced.

Further, as necessary, magnetic powders, for example, metals such as cobalt, iron and nickel, alloys of aluminum, copper, iron, nickel, magnesium, tin, zinc, gold, silver, selenium, titanium, tungsten, zirconium and other metals, metal oxides such as aluminum oxide, iron oxide and nickel oxide, ferrite, magnetite or the like may also be used in the toners according to the present invention.

The loadings of magnetic powder may range usually from 1 to 70% by weight, preferably from 5 to 50% by weight and more preferably from 10 to 40% by weight in relation to 100% by weight of a resin composition.

The average particle diameter of magnetic powder to be used is preferably from 0.01 to 3 μm.

Further, as necessary, various additives, for example, stabilizers (such as ultraviolet absorbers, antioxidants and thermal stabilizers), flame retardants, antifogging agents, dispersants, nucleating agents, plasticizers (such as phthalates, fatty acid-based plasticizers, phosphoric acid-based plasticizers), high molecular weight antistatic agents, low molecular weight antistatic agents, compatibilizers, conduction agents, fillers, flow improvers or the like may also be added to the toners according to the present invention.

The toners according to the present invention may preferably have inorganic microparticles attached on the surface in view of conferring flowability to the toners.

Examples of inorganic microparticles may include silica, alumina, talc, clay, calcium carbonate, magnesium carbonate, titanium oxide, carbon black powders and magnetic powders.

These inorganic microparticles may be used alone or in combination of two or more.

In particular, silica may preferably be used among these inorganic microparticles.

Silica is not particularly limited in terms of average particle diameter, BET specific surface area or surface treatment and may appropriately be selected according to applications. The BET specific surface area may preferably be within the range of 50 to 400 m²/g and surface-treated hydrophobic silica is preferred.

In addition to the inorganic microparticles described above, impalpable resin powder such as polyethylene tetrafluoride resin powder and polyvinylidene fluoride powder may also be attached to the toners according to the present invention.

The proportion of these inorganic microparticles and impalpable resin powder to be added to the toners may range from 0.01 to 8 parts by weight, preferably from 0.1 to 5 parts by weight and more preferably from 0.1 to 4 parts by weight (in particular from 0.3 to 3 parts by weight) in relation to 100 parts by weight of the toners as appropriate.

Outside the ranges described above, the flowability and electrification stability of the toners will degrade, with a result that forming uniform images may be difficult.

The toners according to the present invention are not particularly limited in use by development style and may be used with non-magnetic one-component development, magnetic one-component development, two-component development and other development.

Toners for magnetic one-component development are used as magnetic toners by mixing the magnetic powders described above with binder resins, while toners for two-component development are used as mixed with carriers.

Use as toners for non-magnetic one-component development is preferred in view of equipment convenience and cost.

As carriers for two-component development, nickel, cobalt, iron oxide, ferrite, iron, glass beads or the like may be used, for example.

These carries may be used alone or in combination of two or more.

The carriers may preferably have an average particle diameter within the range of 20 to 150 μm.

Also, the surface of the carriers may be coated with coating materials such as fluorine-based resins, acrylic resins and silicone-based resins.

The toners according to the present invention may be monochrome toners, but may preferably be used as full-color toners.

For monochrome toners, the carbon blacks described above may be used as coloring agents for non-magnetic toners while those black in color among the magnetic powders described above may be used as coloring agents for magnetic toners, in addition to the carbon blacks described above. For full-color toners, the color pigments described above may be used as coloring agents.

Process for Production of Toner

Processes for producing the toners according to the present invention are not particularly limited. Usually, cyclic polyolefinic resins, polar resins, compatibilizers, coloring agents and other additives can be dry blended and melt-kneaded to produce kneaded products, which are then ground and classified to obtain toners having desired particle diameters and particle shapes.

Also, processes may be such that toner particles may be obtained while polymerizing resins.

Among them, a process for producing a toner is preferred, which comprises a step of melt-kneading a cyclic polyolefin resin and a coloring agent to obtain a kneaded product, a step of grinding the kneaded product to obtain colored particles, and a step of melt-kneading, grinding and classifying the colored particles and a polar resin to obtain the toner.

According to the present invention, a cyclic polyolefin resin and a polar resin are used as binder resins. When the cyclic polyolefin resin, the polar resin and the coloring agent are melt-kneaded at a time, however, the polar resin may only be colored to provide uneven coloration in many cases.

As such, the cyclic polyolefin resin and the coloring agent are melt-kneaded in advance and also ground to facilitate maintaining uniformity in color with the polar resin.

For dry blending, methods by means of agitators such as Henschel mixers, super mixers or ribbon mixers may be used.

For thermal melt-kneading, various methods including customarily used methods, such as those by means of double-screw extruders, Banbury mixers, pressurizing rollers and pressurizing kneaders may be used.

For grinding, methods by means of grinders such as hammer mills, cutter mills and jet mills may be used.

For classifying, air classifiers such as dry type centrifugal classifiers may usually be used.

In this manner, classified toners having a volume average particle diameter of 6 to 10 μm may be obtained. The volume average particle diameter is preferably from 6 to 9 μm and more preferably from 6 to 8 μm.

A volume average particle diameter refers to a volume 50% diameter as determined using a particle size characterization instrument (Multisizer II, Beckman Coulter, Inc.).

Also, the inorganic microparticles and the impalpable resin powders described above may be attached to the surface of classified toners using agitators such as turbine impeller mixers, Henschel mixers and super mixers.

### EXAMPLES

The present invention will be described in more detail with reference to examples below, to which the present invention is not limited in any way. Loadings of raw materials are in parts by weight.

### Example 1

The following raw materials were uniformly mixed by a Henschel mixer and then melt-kneaded in a double-screw kneader/extruder to provide a kneaded product, which was left to cool.

Cyclic polyolefin resin (trade name TOPAS COC, Polyplastics Co., Ltd.) 100 parts

Cyan pigment powder (trade name Cyan No. 4, Dainichiseika Color & Chemicals Mfg. Co., Ltd.) 8.0 parts

The kneaded product was then coarsely ground by a hammer mill to provide colored particles.

Then, the following raw materials were uniformly mixed using a super mixer and then melt-kneaded in a double-screw kneader/extruder to provide a kneaded product, which was left to cool.

Colored particles 108 parts

Polyester resin (trade name FC-1142, Mitsubishi Rayon Co., Ltd.) 25 parts

Compatibilizer (trade name CERAMER 67, Baker Petrolite Corporation) 2.0 parts

Charge control agent (trade name LR-147, Japan Carlit Co., Ltd.) 1.0 part

Ester wax (trade name WEP-8, NOF Corporation) 5.0 parts

The kneaded product was then coarsely ground by a hammer mill, pulverized by a jet mill and classified by an air classifier to provide a classified toner having a volume average particle diameter of 8.0 μm.

Then, 100 parts of the classified toner and the following external additives were uniformly mixed by a Henschel mixer to provide a toner of Example 1.

Silica (Nippon Aerosil Co., Ltd., average primary particle diameter 30 nm, BET specific surface area 48 m²/g) 0.2 part

Silica (Cabot Corporation, average primary particle diameter 8 nm, BET specific surface area 200 m²/g) 0.8 part

Titanium oxide (Nippon Aerosil Co., Ltd., average primary particle diameter 10 nm, BET specific surface area 65+/−10 m²/g) 0.5 part

### Example 2

In a manner similar to that of Example 1 except for using 10 parts of the polyester resin, a toner of Example 2 was obtained.

### Example 3

In a manner similar to that of Example 1 except for using 50 parts of the polyester resin and 4.0 parts of the compatibilizer, a toner of Example 3 was obtained.

### Example 4

In a manner similar to that of Example 1 except for using a commercially available polyhydroxyalkanoate resin as a polyester resin, a toner of Example 4 was obtained.

### Example 5

In a manner similar to that of Example 1 except for using a polyester elastomer (trade name Hytrel 3548 L, Du Pont-Toray Co., Ltd.) instead of the polyester resin, a toner of Example 5 was obtained.

### Example 6

In a manner similar to that of Example 1 except for using a styrene-acryl resin (trade name TTR-1399, Fujikura Kasei Co., Ltd.) instead of the polyester resin, a toner of Example 6 was obtained.

### Comparative Example 1

In a manner similar to that of Example 1 except for using 8 parts of the polyester resin, a toner of Comparative Example 1 was obtained.

### Comparative Example 2

In a manner similar to that of Example 1 except for using 60 parts of the polyester resin and 4.0 parts of the compatibilizer, a toner of Comparative Example 2 was obtained.

Principal conditions for Examples and Comparative Examples are shown in Table 1.

TABLE 1

| | | polar resin in | compatibilizer in |
|---|---|---|---|
| | | relation to 100 | relation to 100 |
| | | parts of cyclic | parts of cyclic |
| | polar resins | polyolefin | polyolefin |
| Ex. 1 | Polyester resin | 25 parts | 2 parts |
| Ex. 2 | Polyester resin | 10 parts | 2 parts |
| Ex. 3 | Polyester resin | 50 parts | 4 parts |
| Ex. 4 | polyester resin | 25 parts | 2 parts |
| | (polyhydroxy- | | |
| | alkanoate resin) | | |
| Ex. 5 | polyester | 25 parts | 2 parts |
| | elastomer | | |
| Ex. 6 | styrene-acryl | 25 parts | 2 parts |
| | resin | | |
| Com. Ex. 1 | Polyester resin | 8 parts | 2 parts |
| Com. Ex. 2 | Polyester resin | 60 parts | 4 parts |

The toners from Examples and Comparative Examples were evaluated as follows.

Sticking and Curling

An amount of toner corresponding to 15,000 sheets was fed to a commercially available, non-magnetic, one-component full-color printer and was used to print 10,000 sheets of A4 (longitudinal direction) transfer paper (PPC sheets from Nippon Paper Group, Inc., 64 g/m²) at a print rate of 6%.

Thereafter, with no toner refilling, solid unfixed images were produced on ten sheets of A4 (longitudinal direction) transfer paper (PPC sheets from Nippon Paper Group, Inc., 64 g/m²) leaving 4 mm of margins on four sides.

Deposits of the toner of the transfer paper were adjusted by toner density, surface potential of photosensitive materials, development potential, exposure amount and transfer conditions to approximately 2.0 mg/cm² (corresponding to approximately 20 μm in thickness of toner with three colors).

Then, an oilfree fixing machine in which a thermal fixation roller whose surface layer is made of polyethylene tetrafluoride and a pressure fixation roller whose surface layer is made of a silicone rubber rotate in a pair was adjusted so that the roller pressure may be at 1 Kgf/cm and the roller speed may be at 125 mm/sec.

Then the unfixed images were fixed at a surface temperature of the thermal fixation roller at 180° C. and the occurrences of sticking and curling were counted.

With one or less occurrence of sticking and curling, it was considered allowable in practical applications.

Odor

Immediately after the determination of sticking and curling as described above, ten people were asked to smell around the printer and the number of people who smelled of any strong odor was counted.

With three or less people who smelled, it was considered allowable in practical applications.

The results are shown in Table 2

TABLE 2

| | sticking and curling | odor |
|---|---|---|
| Ex. 1 | 0 | 1 |
| Ex. 2 | 0 | 0 |
| Ex. 3 | 1 | 3 |
| Ex. 4 | 0 | 0 |
| Ex. 5 | 0 | 0 |
| Ex. 6 | 0 | 0 |
| Com. Ex. 1 | 8 | 0 |
| Com. Ex. 2 | 0 | 9 |

Evaluation of Result

As apparent from Table 2, the toners from Examples 1 to 6 suffered no practical problems.

Although slight polyester odor was sensed in Example 1 and one occurrence of sticking and curling and some polyester odor were found in Example 3, they were considered allowable in practical applications.

On the contrary, eight occurrences of sticking and curling were experienced in Comparative Example 1, causing problems in practical applications.

Also in Comparative Example 2, polyester odor was so strong that it caused practical problems.

1. A toner for developing electrostatically charged images, comprising a cyclic polyolefinic resin and a polar resin, wherein 10 to 50 parts by weight of the polar resin is present in relation to 100 parts by weight of the cyclic polyolefinic resin.

2. The toner for developing electrostatically charged images according to claim 1, further comprising a compatibilizer.

3. The toner for developing electrostatically charged images according to claim 2, wherein the compatibilizer comprises a polymer having both non-polar and polar segments.

4. The toner for developing electrostatically charged images according to claim 1, wherein the polar resin comprises a styrene-acrylic resin or polyester-based resin.

5. The toner for developing electrostatically charged images according to any one of claims 1 to 4, further comprising a wax.

6. A process for producing a toner for developing electrostatically charged images, comprising
a step of melt-kneading at least a cyclic polyolefinic resin and a coloring agent to obtain a kneaded product,
a step of grinding the kneaded product to obtain colored particles, and
a step of melt-kneading, grinding and classifying the colored particles and a polar resin to obtain the toner.
